(19) United States
(12) Patent Application Publication
(10) Pub. No.: US 2020/0130493 A1
(43) Pub. Date: Apr. 30, 2020

(54) Hail protection cover for a vehicle

(71) Applicants: Michael Bad Wound, Northglenn, CO (US); Anthony Montoya, Northglenn, CO (US)

(72) Inventors: Michael Bad Wound, Northglenn, CO (US); Anthony Montoya, Northglenn, CO (US)

(21) Appl. No.: 16/172,789

(22) Filed: Oct. 27, 2018

(51) Int. Cl. B60J 11/04

(52) U.S. Cl. CPC B60J 11/04

(57) ABSTRACT

The invention is directed to a hail protection cover for a vehicle. The cover is comprised of a plurality of roof panels, hood panels, and side skirt panels, which are manufactured from a flexible, durable material. The cover is affixed to the roof of the user's vehicle in a rolled up condition. Upon the approach of a hailstorm, the user may pull the vehicle onto the should of the highway, unroll the cover, and unfold the panels to cover and protect the vehicle. The user may then re-enter the vehicle and wait for the hailstorm to pass before folding and rolling the cover.

This application relates back to, and claims the priority of Provisional Patent Application No. 62/618,026 filed on Jan. 16, 2018.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to vehicle accessories, and in particular to a hail protection cover for a vehicle. Millions of vehicle owners are familiar with the difficulties of protecting their vehicles from hail damage, particularly when there is no garage, carport, or other roofed structure available to protect the vehicle. Some drivers elect to drive at unsafe speeds, seeking to park the vehicle under an overhead highway structure such as a viaduct. Usually the response is to allow the hail damage to occur, and file an insurance claim. The costs and problems that arise from being forced to seek estimates, get the repair work done, and pay the deductible are seen as something that simply must be accepted. In cases of extreme damage such as the destruction of a windshield, the owner may even need to rent a vehicle until the damage can be repaired.

A search of the prior art reveals various devices which have been developed to address this set of problems, or related problems. None are closely related to the present invention, but several include features which resemble those of the present invention. Each has proven to be less than satisfactory for the present purpose in its own way.

Protective hail cover for vehicles, U.S. Pat. No. 6,044,881 (priority Oct. 28, 1998), provides a cover which protects a vehicle from damage by weather. The cover has a flexible shell that is located over the surface of the vehicle. The shell is spaced from the surface by at least one inflatable tube. The inflatable tube is coupled to the underside of the shell by way of an attachment tube. The attachment tube is coupled to the underside of the shell by way of one or more flaps. The attachment tube has an interior cavity that receives the inflatable tube therein. The attachment tube has plural lengths, with each length extending adjacent to at least one other length. The lengths are separated from each other by gaps so as to space apart the attachment tubes and minimize the weight of the cover. A single attachment tube and a single inflatable tube can be used, wherein the tubes are laid out on the shell in a spiral or a zig zag pattern.

Hail cover for vehicles, U.S. Pat. No. 6,439,644 (priority Oct. 12, 1999), provides a device for a cover on a vehicle, group of vehicles or building whereby the vehicles are protected from falling hail during a hail storm. The present invention comprises a flexible cover having an air blower for constantly supplying air to the cover along with spring-loaded outlet air valves whereby a preset pressure is maintained in the cover. The cover operates somewhat on the principle of a hovercraft according to dynamic physics. An air blower is also provided along with straps for holding the cover onto the vehicle.

Hail protective vehicle cover, U.S. Pat. No. 5,401,074 (priority Nov. 10, 1992), provides a vehicle cover that protects a vehicle from hail and other falling objects and is easily installed, removed, and stored in the trunk of the vehicle. The cover is substantially comprised of a sheet of cloth, several foam runners, and several attaching straps. The foam runners, preferably having a rectangular cross section, attach to the underside of the cloth. When placed on a vehicle, the foam runners support the cloth in a spaced apart relationship with the top of the vehicle. The attaching straps securely attach the cover to the vehicle by attaching to the wheel wells and the front and rear bumpers of the vehicle. The attaching straps hold the cloth in a taut condition so that the cloth remains in a spaced apart relationship with the top of the vehicle. Falling objects, such as hail, are repelled by the taut cloth and damage to the vehicle is prevented. The foam runners and straps are adjustable so that the cover fits a variety of vehicles.

Impact protective car cover, U.S. Pat. No. 5,800,006 (priority Oct. 4, 1996), provides a protective vehicle cover for the prevention and reduction of damage from hail and similar free falling bodies. A reversible waterproof vinyl on two sides of an impact resistant plastic material covers the top, sides, front, and rear surfaces of a vehicle. The impact resistant material transmits the force of the impact to its opposing side to reduce the amount of force per unit of area so as to prevent damage as the force is transmitted to the vehicle. Utilization of the impact resistant material permits a product which is light weight, compact, portable, and stores easily in a vehicle trunk compartment.

Mobile vehicle hail cover, U.S. Pat. No. 6,893,074 (priority Mar. 17, 2004), provides a protective barrier for the top surfaces of a motor vehicle, from the damaging effects of falling hail, during a sudden hall storm, while the vehicle is under operation on the roadways, providing completely street legal operation, or when parked. The invention consists of two or three composite protective cover sheets of flexible rubberized and weatherproof material. The cover sheet for the roof, is connected to the sheets on the hood and trunk by way of elastic straps. The hood and trunk sheets are attached to the vehicle by the elastic straps at each corner, connecting to rubber coated metal hooks on the ends, to securely anchor the entire apparatus to the vehicle. This invention, can help automobile Insurance companies, realize the savings of money in hail damage claims and prevent potential freeway accident pileups, due to drivers stopping under bridges and freeway overpasses.

Fortunately, an after-market accessory is available which can be used to prevent hail damage from occurring. A hail protection cover for a vehicle, which provides a sturdy protective cover which may be rapidly deployed to temporarily cover the vehicle, would resolve this problem.

### SUMMARY OF THE INVENTION

Accordingly, the invention is directed to a hail protection cover for a vehicle. The cover is comprised of a plurality of roof panels, hood panels, and side skirt panels, which are manufactured from a flexible, durable material. The cover is affixed to the roof of the user's vehicle in a rolled up condition. Upon the approach of a hailstorm, the user may pull the vehicle onto the should of the highway, unroll the cover, and unfold the panels to cover and protect the vehicle. The user may then re-enter the vehicle and wait for the hailstorm to pass before folding and rolling the cover.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 provides a side view and a side perspective view of the first exemplary embodiment in the rolled up condition, affixed to the roof of a vehicle, displaying the cover 10, and the vehicle 14.

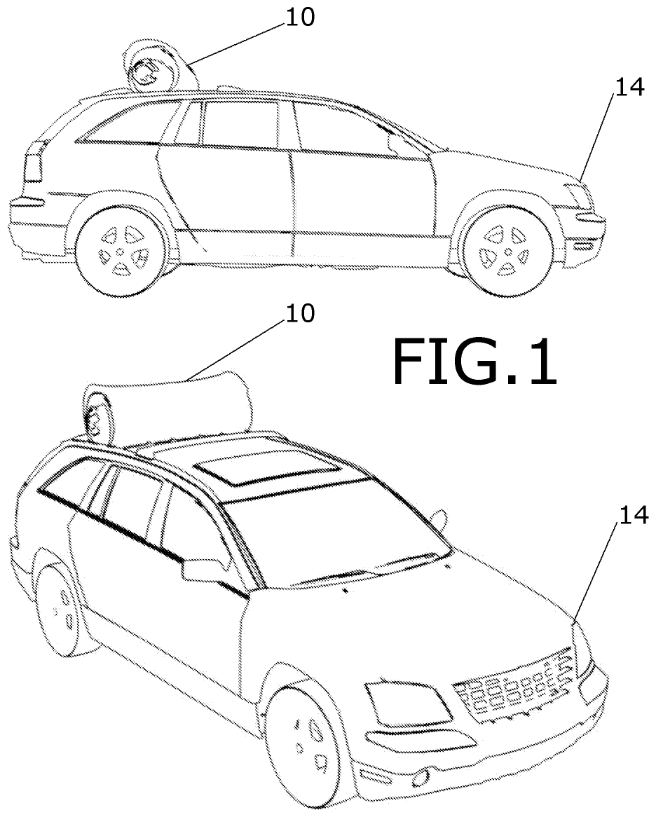

FIG. 2 provides a side view and a side perspective view of the first exemplary embodiment in a 25% unrolled condition, affixed to the roof of a vehicle, displaying the cover 10, the rear panels 10A, the grommets 10B, the side skirt panels 13, and the vehicle 14.

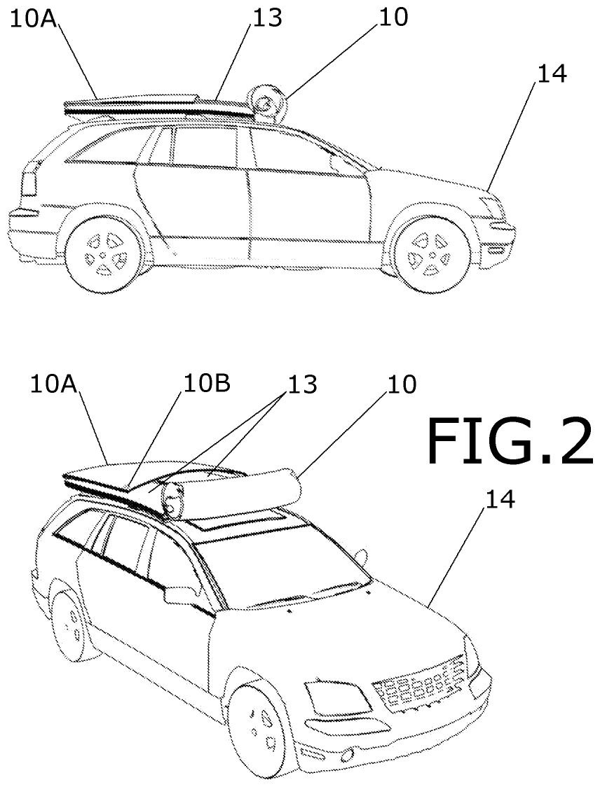

FIG. 3 provides a side view and a side perspective view of the first exemplary embodiment in a 50% unrolled condition, affixed to the roof of a vehicle, displaying the cover 10, the rear panels 10A, the grommets 10B, the side skirt panels 13, and the vehicle 14.

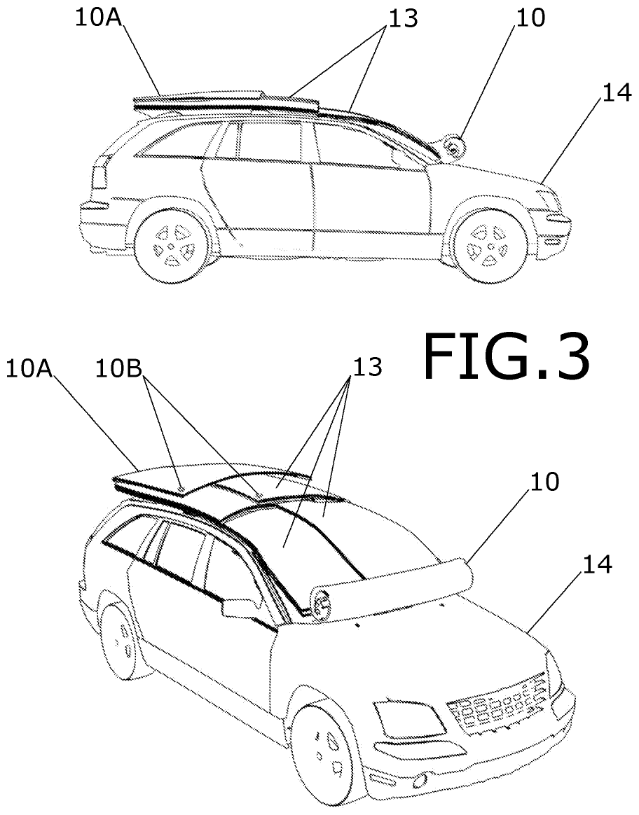

FIG. 4 provides a side view and a side perspective view of the first exemplary embodiment in a 100% unrolled condition, affixed to the roof of a vehicle, displaying the cover 10, the rear panels 10A, the grommets 10B, the side skirt panels 13, and the vehicle 14.

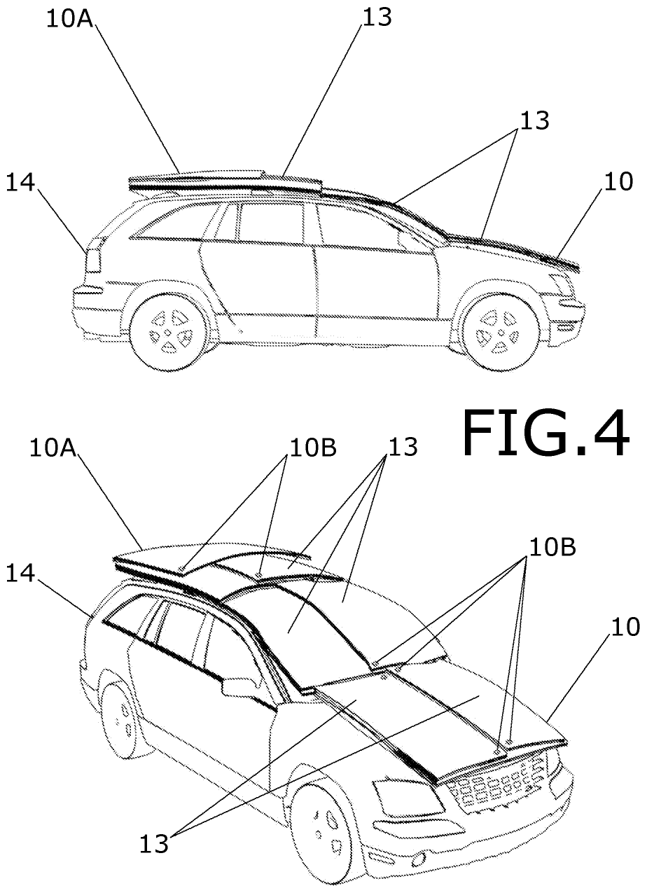

FIG. 5 provides a side view and a side perspective view of the first exemplary embodiment in the fully deployed condition, affixed to the roof of a vehicle, displaying the cover 10, the grommets 10B, the roof panels 11, the hood panel 12, the side skirt panels 13, the front panel 13A, and the vehicle 14.

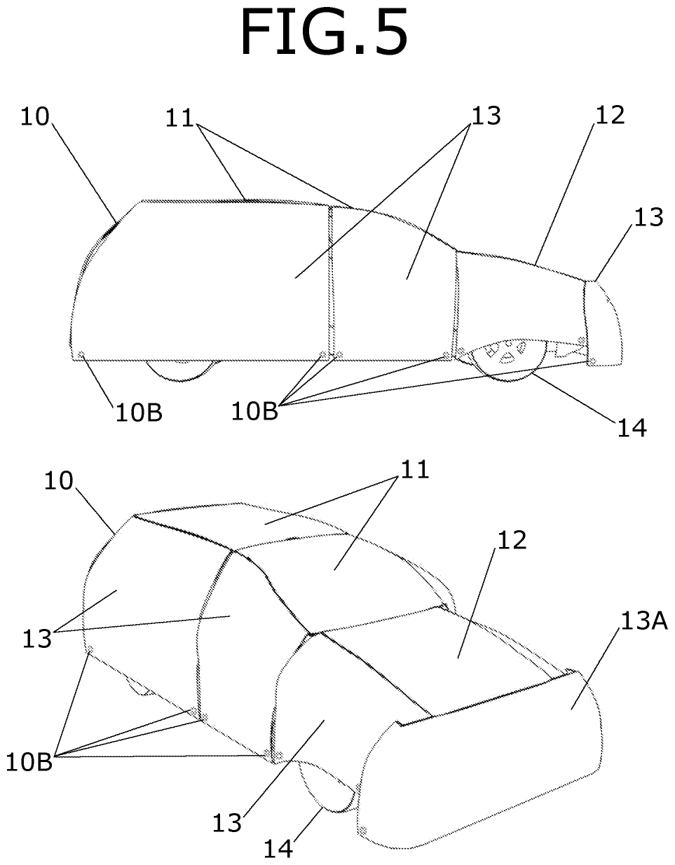

### DETAILED DESCRIPTION OF THE INVENTION

Referring now to the invention in more detail, the invention is directed to a hail protection cover 10 for a vehicle 14.

It is to be understood that the invention is intended for use as an after-market modification for the user's vehicle, to be purchased and installed by the user, or by a repair or customizing shop. Alternate embodiments, which may be installed as original equipment by the manufacturer of the vehicle, are contemplated.

The first exemplary embodiment is comprised of a cover 10 which is contained in a compact, cylindrical roll, aligned across the roof of the user's vehicle 14 and secured to the roof with magnets, provided within the cover 10. The cover 10 provides a plurality of rear panels 10A, roof panels 11, hood panels 12, and side skirt panels 13, and further provides a front panel 13A. The panels are separated by seams. The panels may be folded along the seams, and then the cover 10 may be rolled up for storage. Grommets 10B are provided at the lower corners of all panels, such that the user may secure them together with bungee cords or other tie-down fasteners. This secures the cover 10 to the vehicle 14 in the event of high winds.

The side panels 13 provide additional magnets which enable the user to secure the side panels 13 to the side surfaces of the vehicle 14 below the windows. The cover 10 provides a layer of high density foam padding to protect the user's vehicle 14 from damage due to the impact of hailstones. The cover 10 is provided in several versions, corresponding to popular makes and models of automobiles, pickup trucks, and sport utility vehicles. The cover 10 may be provided in alternate embodiments to cover and protect other objects, such as large trucks and boats.

The first exemplary embodiment is intended for manual operation for the purpose of reducing manufacturing costs and keeping the purchase price affordable. Alternate embodiments may be electrically operated by remote control, providing servomotors to open the cover 10. Other alternate embodiments may operate automatically, providing a communications device which monitors weather alerts such that the cover 10 will activate and deploy in response to a hailstorm warning if the vehicle 10 is not moving.

To use the first exemplary embodiment, the user opens and unrolls the cover 10 upon the approach of a hailstorm. The user then unfolds the panels such that the entire vehicle 14 is covered. The user may then re-enter the vehicle 14 and wait for the hailstorm to pass before folding and rolling the cover 10. Optionally, in the event of high winds, the user may secure the cover 10 to the vehicle 14 with the grommets 10B which are provided at the lower corners of all panels, such that the user may secure the grommets 10B together with bungee cords or other tie-down fasteners.

The cover 10 is preferably manufactured from a flexible, durable material with substantial tensile strength, such as heavy-gauge vinyl or rubberized canvas, with a layer of padding which is preferably manufactured from high density foam rubber. The grommets 10B are preferably manufactured from a rigid, durable, corrosion resistant material with substantial structural strength, such as plastic, brass, or aluminum alloy. Components and methods listed above are preferable, but artisans will recognize that alternate components and methods could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A hail protection cover for a vehicle, which is contained in a compact, cylindrical roll, aligned across the roof of the user's vehicle and secured to the roof with magnets, provided within the cover, and providing a plurality of rear panels, roof panels, hood panels, and side skirt panels, and further provides a front panel, all panels being separated by seams.

2. The cover of claim 1, wherein the panels may be folded along the seams, and then the cover may be rolled up for storage.

3. The cover of claim 1, wherein grommets are provided at the lower corners of all panels, such that the user may secure them together with bungee cords or other tie-down fasteners, thereby securing the cover to the vehicle in the event of high winds.

4. The cover of claim 1, wherein the side panels provide additional magnets which enable the user to secure the side panels to the side surfaces of the vehicle below the windows.

5. The cover of claim 1, wherein the cover provides a layer of high density foam padding to protect the user's vehicle from damage due to the impact of hailstones, and is provided in several versions, corresponding to popular makes and models of automobiles, pickup trucks, and sport utility vehicles.

6. The cover of claim 1, wherein the user opens and unrolls the cover upon the approach of a hailstorm, then unfolds the panels such that the entire vehicle is covered.

7. The cover of claim 1, wherein the user may then re-enter the vehicle and wait for the hailstorm to pass before folding and rolling the cover.

8. The cover of claim 1, wherein optionally, in the event of high winds, the user may secure the cover to the vehicle with the grommets which are provided at the lower corners of all panels, such that the user may secure the grommets together with bungee cords or other tie-down fasteners.

9. The cover of claim 1, wherein the cover is preferably manufactured from a flexible, durable material with substantial tensile strength, such as heavy-gauge vinyl or rubberized canvas, with a layer of padding which is preferably manufactured from high density foam rubber.

10. The cover of claim 1, wherein the grommets are preferably manufactured from a rigid, durable, corrosion resistant material with substantial structural strength, such as plastic, brass, or aluminum alloy.
